(19) United States
(12) Patent Application Publication
(10) Pub. No.: US 2003/0234716 A1
(43) Pub. Date: Dec. 25, 2003

(54) Fuse assembly

(76) Inventor: Chin-Chi Yang, Taichung (TW)

Correspondence Address: Rabin & Berdo, P.C., Suite 500, 1101 14th Street, Washington, DC, 20005, US

(21) Appl. No.: 10/175,039

(22) Filed: Jun. 20, 2002

(51) Int. Cl. H01H 85/175; H01H 85/08

(52) U.S. Cl. 337/187; 337/227; 337/228

(57) ABSTRACT

A fuse assembly includes an insulation body, two conductors respectively mounted on two distal ends of the insulation body, a fuse extending between the two conductors, and an enclosure encapsulating the insulation body, the conductors and the fuse entire foregoing parts.

### BACKGROUND OF THE INVENTION

1. Field of the Invention

The present invention relates to a fuse assembly, and more particularly to a fuse assembly having a body made of porcelain, two conductors respectively mounted on two distal ends of the body and a fuse attached to a side of the body and extending out of the two conductors.

2. Description of Related Art

It is known that a fuse assembly is designated to provide a warning and a safety measure to the user. That is, if the temperature of the wire is too high and over the melting point of the material which is used to make the fuse, the fuse inside the fuse assembly breaks to cause a temporary power failure such that fire is prevented and the user is alerted to the overload situation.

With reference to FIG. 4, a conventional fuse assembly is shown and has a hollow tube (50) with two closed ends, a fuse (60) extending through the hollow tube (50), an epoxy resin (62) securely enclosing a periphery of the hollow tube (50) and two conductors (63) securely connected to two distal ends of the hollow tube (50) as well as two distal ends of the fuse (60). The two distal ends of the fuse (60) are therefore feet (61) for a circuit board (not shown).

When the fuse assembly of this kind is used and the temperature of the fuse (60) rises due to the electrical current, air inside the hollow tube (50) expands as a result of the rising temperature. Eventually, the hollow tube (50) explodes and hence the circuit board is damaged.

To overcome the shortcomings, the present invention tends to provide an improved fuse assembly to mitigate and obviate the aforementioned problems.

### SUMMARY OF THE INVENTION

The primary objective of the present invention is to provide an improved fuse assembly which has little air left inside the assembly so that explosion due to the rising temperature is avoided.

In order to accomplish the objective, the fuse assembly of the present invention has a body made of porcelain, a fuse securely attached to a side of the body, two conductors respectively connected to two distal ends of the body and an enclosure encapsulating the body.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional side plan view showing the internal relationship between parts;

FIG. 2 is an exploded plan view showing the parts of the fuse assembly of the present invention;

FIG. 3 is a cross sectional side plan view showing another preferred embodiment of the present invention; and

FIG. 4 is a cross sectional view showing a conventional fuse assembly.

### DETAILED DESCRIPTION OF THE PREFERRED EMBODIMENT

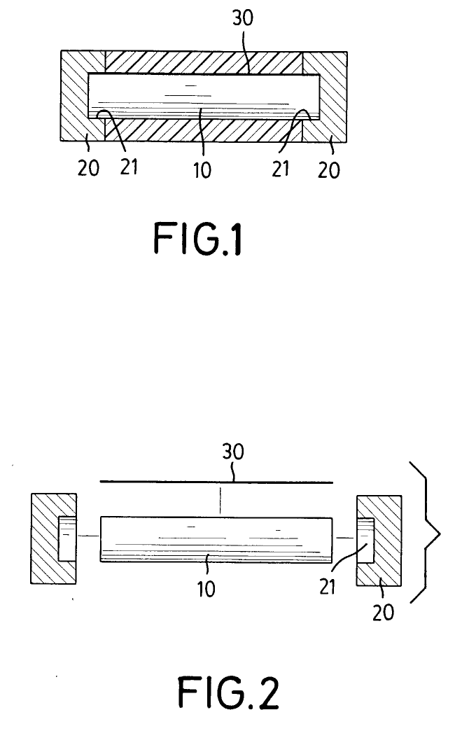

With reference to FIGS. 1 and 2, the fuse assembly in accordance with the present invention has an insulation body (10), two conductors (20) respectively mounted on two distal ends of the insulation body (10), a fuse (30) welded to a side of the insulation body (10) and extending between the two conductors (20) and an enclosure encapsulating the entire foregoing parts.

With reference to FIG. 2, the insulation body (10) is preferably made of porcelain and is cylindrical in shape. The conductor (20) is made of brass and has a recess (21) defined to correspond to a distal end of the cylindrical insulation body (10) so that the insulation body (10) is able to connect to the conductor (20) via the recess (21). The fuse (30) is securely attached to a side of the insulation body (10) and extends into the recesses (21) of the conductors (20) which are respectively and securely connected to two distal ends of the insulation body (10). After the extension of the fuse (30) into the conductors (20), the fuse (30) is welded with each one of the conductors (20).

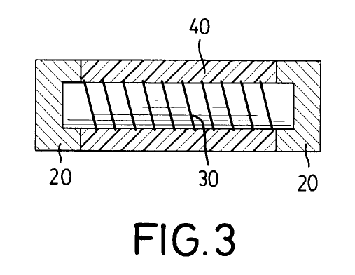

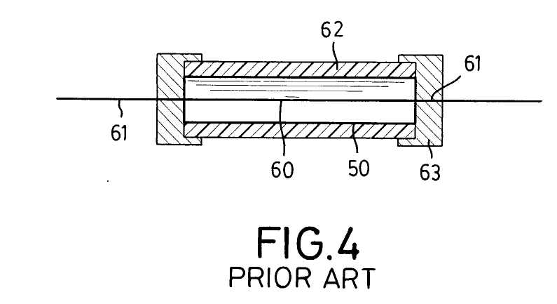

With reference to FIG. 3, from another embodiment of the present invention, it is noted that the fuse (30) is spirally mounted around the insulation body (10). Furthermore, the insulation body (10) can also be made of a magnetic material so that the insulation body (10) is able to filter out radio interference.

It is concluded that the fuse assembly has only little air left inside the assembly so that explosion is avoided. The quantity of the parts is reduced when compared with a conventional fuse assembly so that the fuse assembly of the present invention is easy to be assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fuse assembly comprising:
an insulation body;
two conductors respectively mounted on two distal ends of the insulation body;
a fuse extending between the two conductors and securely attached to a side of the insulation body; and
an enclosure encapsulating the insulation body, the conductors and the fuse entire foregoing parts, whereby little air is left inside the fuse assembly such that explosion is prevented.

2. The fuse assembly as claimed in claim 1, wherein the fuse is welded to each one of the conductors.

3. The fuse assembly as claimed in claim 1, wherein the fuse is spirally mounted around the insulation body.

4. The fuse assembly as claimed in claim 2, wherein the fuse is spirally mounted around the insulation body.

5. The fuse assembly as claimed in claim 3, wherein the insulation body is made of a magnetic material.

6. The fuse assembly as claimed in claim 4, wherein the insulation body is made of a magnetic material.
